(19) United States
(12) Patent Application Publication
(10) Pub. No.: US 2020/0256999 A1
(43) Pub. Date: Aug. 13, 2020

(54) LIDAR TECHNIQUES FOR AUTONOMOUS VEHICLES

(71) Applicants: Atulya Yellepeddi, Cambridge, MA (US); Ravi Kiran Raman, Cambridge, MA (US); Jennifer Tang, Norwood, MA (US); Sefa Demirtas, Winchester, MA (US); Miles R. Bennett, Stanford, CA (US); Christopher Barber, Roslindale, MA (US)

(72) Inventors: Atulya Yellepeddi, Cambridge, MA (US); Ravi Kiran Raman, Cambridge, MA (US); Jennifer Tang, Norwood, MA (US); Sefa Demirtas, Winchester, MA (US); Miles R. Bennett, Stanford, CA (US); Christopher Barber, Roslindale, MA (US)

(21) Appl. No.: 16/783,975

(22) Filed: Feb. 6, 2020

Related U.S. Application Data
(60) Provisional application No. 62/802,691, filed on Feb. 7, 2019.
(60) Provisional application No. 62/824,666, filed on Mar. 27, 2019.
(60) Provisional application No. 62/923,827, filed on Oct. 21, 2019.

(51) Int. Cl. G01S 17/894; G01S 17/931; G01S 7/48; G01S 17/58

(52) U.S. Cl. CPC G01S 17/894; G01S 17/58; G01S 7/4808; G01S 17/931

(57) ABSTRACT

A Laser Imaging Detection and Ranging (LIDAR) system comprises a memory configured to store LIDAR measurement data obtained by the LIDAR system representative of a three-dimensional (3D) space in a field of view of the LIDAR system and signal processing circuitry. The signal processing circuitry is and configured to convert the LIDAR measurement data to a voxel characteristic of voxels of the 3D space, process and adjust a voxel characteristic of a first voxel of the 3D space using a voxel characteristic of other voxels within a specified distance of the first voxel in the 3D space, continue to process and adjust the voxel characteristics of all voxels in the 3D space, and generate an indication of presence of an object in the field of view according to the adjusted voxel characteristics.

### CLAIM OF PRIORITY

This application claims the benefit of priority to U.S. Provisional Application Ser. No. 62/802,691, filed Feb. 7, 2019, U.S. Provisional Application Ser. No. 62/824,666, filed Mar. 27, 2019, and U.S. Provisional Application Ser. No. 62/923,827, filed Oct. 21, 2019, which are hereby incorporated by reference in their entirety.

### FIELD OF THE DISCLOSURE

This document relates generally to Laser Imaging Detection and Ranging (LIDAR) systems.

### BACKGROUND

A LIDAR system can be used for machine vision, and also for vehicle navigation. LIDAR systems may include a transmit channel that can include a laser source to transmit a laser signal, and a receive channel that can include a photo-detector to detect a reflected laser signal. For applications such as vehicle navigation it is desirable for the LIDAR system to detect objects at distance, but a LIDAR system can be become more susceptible to noise as the imaging distance is increased. Typically, the power of the transmit channel is increased to improve the detection distance but this increase in power conumption cab e undesirable.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram depicting various aspects of a light detection and ranging (LIDAR) system.

FIG. 2 is a diagram depicting a LIDAR operating principle.

FIG. 3 includes graphs depicting the power decay in a received LIDAR pulse over range.

FIG. 4 includes illustrations of examples of LIDAR scanning.

FIGS. 5-8 are block diagrams of examples of LIDAR systems.

FIG. 9 includes graphs depicting examples of configurable thresholding for LIDAR scanning.

FIGS. 10-11 are block diagrams of further examples of LIDAR systems.

FIG. 12 includes illustrations depicting an example of multi-spot probability processing and denoising.

FIG. 13 is a block diagram of another example of a LIDAR system.

FIG. 14 is a conceptual diagram of another example of a LIDAR system.

FIG. 15 is a conceptual diagram of an example of a signal processing chain for a LIDAR system.

FIGS. 16-19 include graphs illustrating computations for a belief propagation technique for detecting objects using LIDAR.

FIG. 20 is a flow diagram for computations for the belief propagation technique.

FIG. 21 shows a comparison of performance for various algorithms used to detect objects using LIDAR.

FIG. 22 is a flow diagram illustrating convergence of results for the belief propagation technique for detecting objects using LIDAR,

FIG. 23 illustrates results of LIDAR detection using the belief propagation technique.

FIGS. 24A-D and 25 illustrate identifying clusters of points detected in LIDAR image frames.

FIGS. 26A-C illustrate results of detecting objects in in LIDAR image frames using clustering.

### DETAILED DESCRIPTION

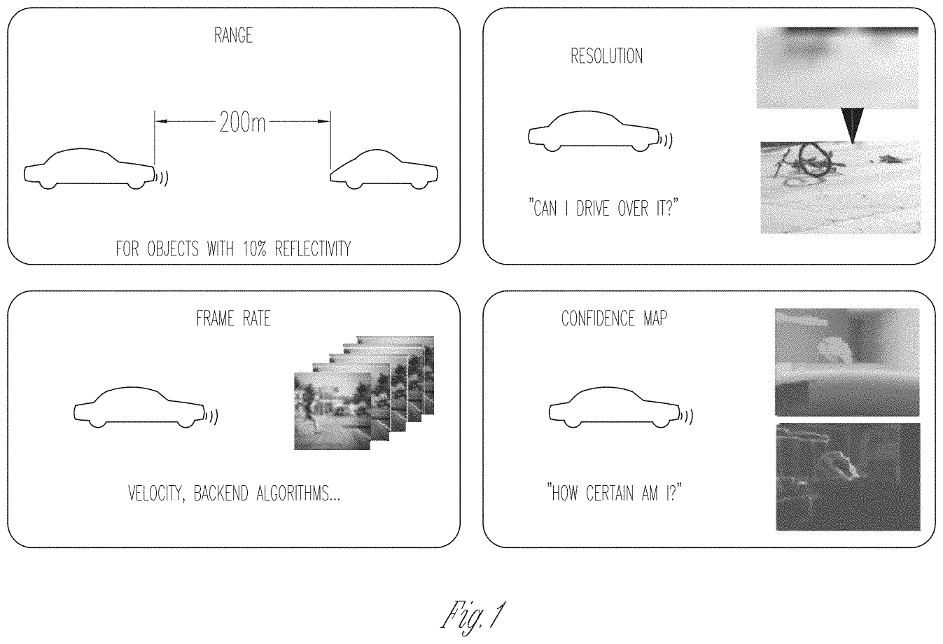

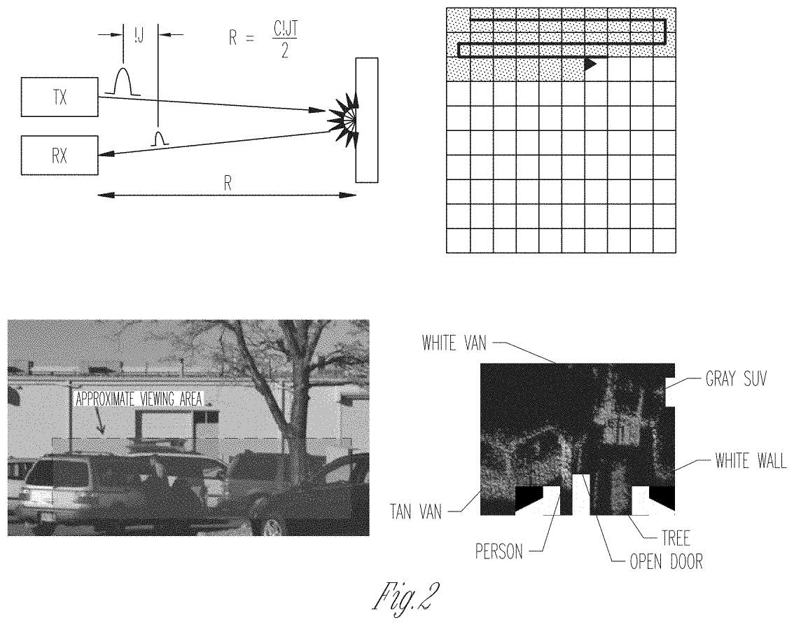

FIG. 1 is a conceptual diagram depicting various aspects of a Laser Imaging Detection and Ranging (LIDAR) system that can generally be considered to be in tradeoff space. Various parameters of the LIDAR system can be adjusted to improve one or more of a range, a resolution, a frame rate, and a confidence map of the LIDAR system. However, an increase in one can result in a decrease in another.

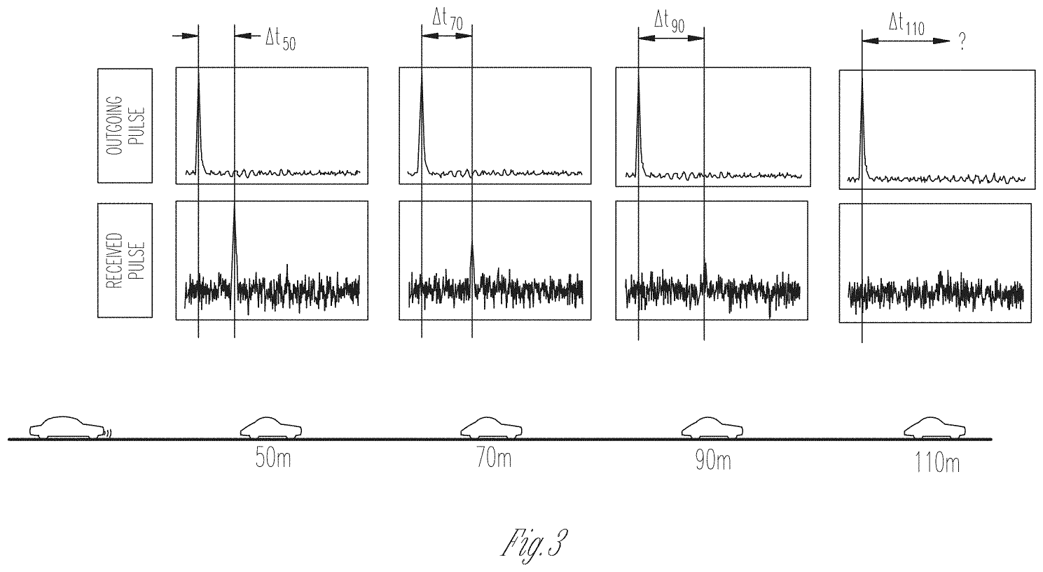

FIG. 2 is a conceptual diagram depicting a LIDAR operating principle. LIDAR systems, such as automotive LIDAR systems, may operate by transmitting one or more light, pulses of light towards a target region. The one or more transmitted light, e.g., laser pulses can illuminate a portion of the target region. A portion of the one or more transmitted light pulses can be reflected and/or scattered by an object in the illuminated portion of the target region and received by the LIDAR system. The LIDAR system can then measure a time difference between the transmitted and received light pulses, such as to determine a distance between the LIDAR system and the illuminated object. The distance can be determined according to the expression

$$R = \frac{c Δ t}{2} ,$$

where R can represent a distance from the LIDAR system to the illuminated object, Δt can represent a round trip travel time, and c can represent a speed of light.

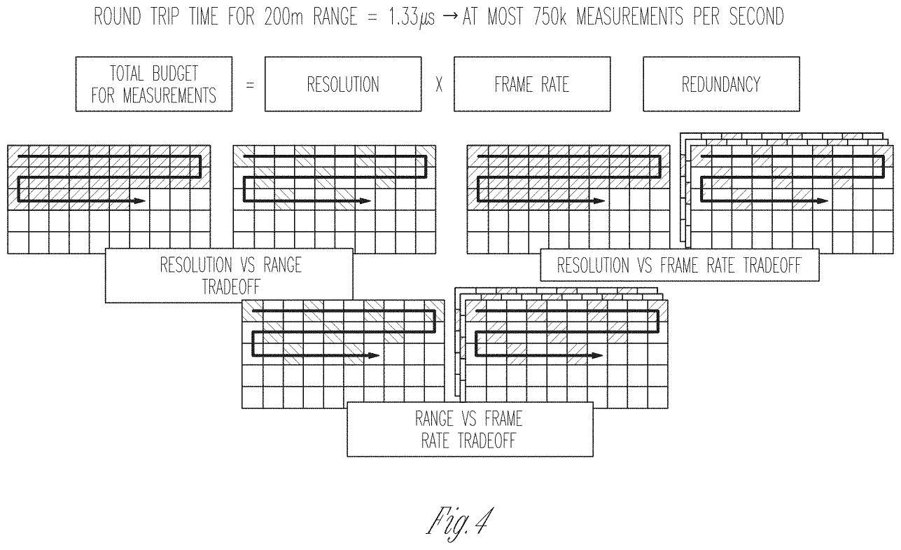

FIG. 3 shows various conceptual graphs depicting the power decay in a received pulse over range, For objects at 50 meters (m) and 70 m, the received pulses are clearly observable in the graphs. However, for an object at 90 m, the received pulse is less observable and for an object 110 m, the received pulse is unobservable, e.g., indistinguishable from the noise floor.

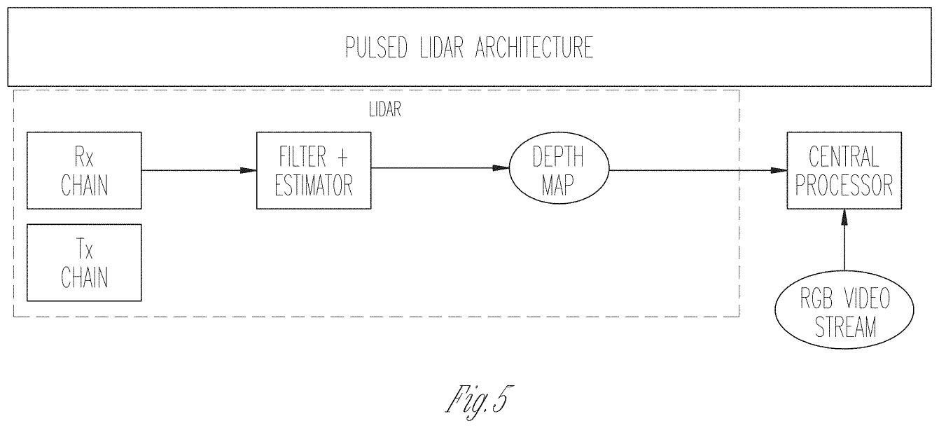

FIG. 4 shows examples of LIDAR scanning, including the flexibility of the present approach in trading off range, resolution, frame rate, and redundancy, which can form a composite total budget for LIDAR measurements. Essentially, the tradeoff occurs because a single measurement takes a fixed amount of time because the pulse of light has to travel a certain distance, e.g., 200 m, and return and, as such, the LIDAR system can be fundamentally limited by the number of measurements that can be taken over a period of time (e.g., 1 second).

An example of a tradeoff is shown in the top left frame of FIG. 4, in which all pixels can be serially scanned, such as for a particular range and resolution corresponding to a particular total composite budget. To the right of the top left frame of FIG. 4, a frame is shown in which fewer than all pixels are scanned (e.g., every third pixel). This allows those pixels that are scanned to be scanned in a manner than can provide greater range (which can optionally be traded off for another purpose). For example, those pixels that are selected to be scanned can be scanned at higher power or measured repeatedly. Those pixels that are skipped can optionally be interpolated or determined using another technique, such as via sensor fusion with data from another (e.g., higher resolution) sensor (e.g., RGB video, radar, infrared sensor, or the like).

Proceeding to the next frame shown to the right on FIG. 4, the resolution in this scan can be traded for a higher frame rate, such as shown in the next image to the tight in FIG. 4. The higher frame rate can yield redundancy, such as more frequent but lower resolution LIDAR images. In FIG. 4, the lower images show how resolution that has been traded for range can instead be traded for higher frame rate or redundancy.

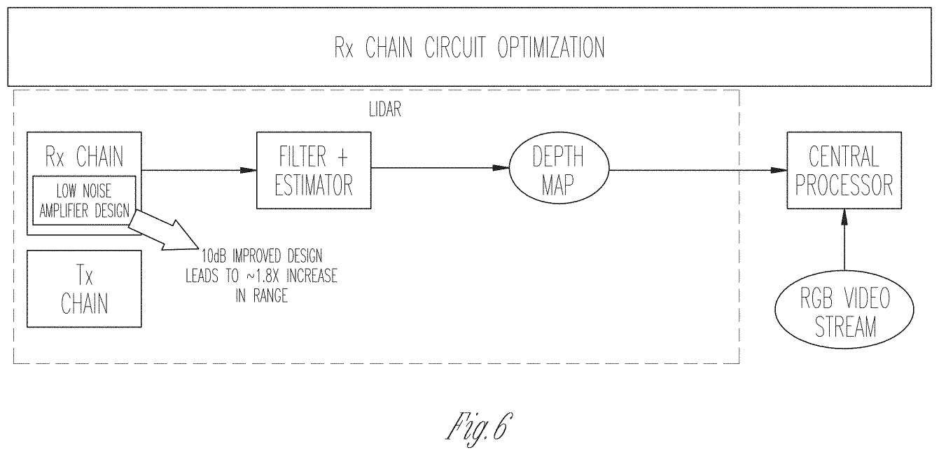

FIG. 5 is a simplified block diagram of a LIDAR system that can implement various techniques of this disclosure. LIDAR systems generally include at least two functional blocks. The first block is the transmit chain (Tx Chain), which is responsible for generating and transmitting the illumination and all related functionality. The second block is the receive chain (Rx Chain), which is responsible for detecting the reflected illumination. The processing circuitry can be used to schedule a LIDAR pulse for transmission and to interpret the depth information from the receive chain.

Within the receive chain, a filter and estimator circuit can be included. The filter circuit can be configured to filter the received signal using one or more time domain coefficients and/or frequency domain coefficients applied to a mathematical operation. Also within the receiver chain is a depth map circuit that can generate a depth map based on spatial coordinates and depth values. The depth map can be applied to a central processor along with an RGB video stream, for example, and the processor can generate an image using these inputs.

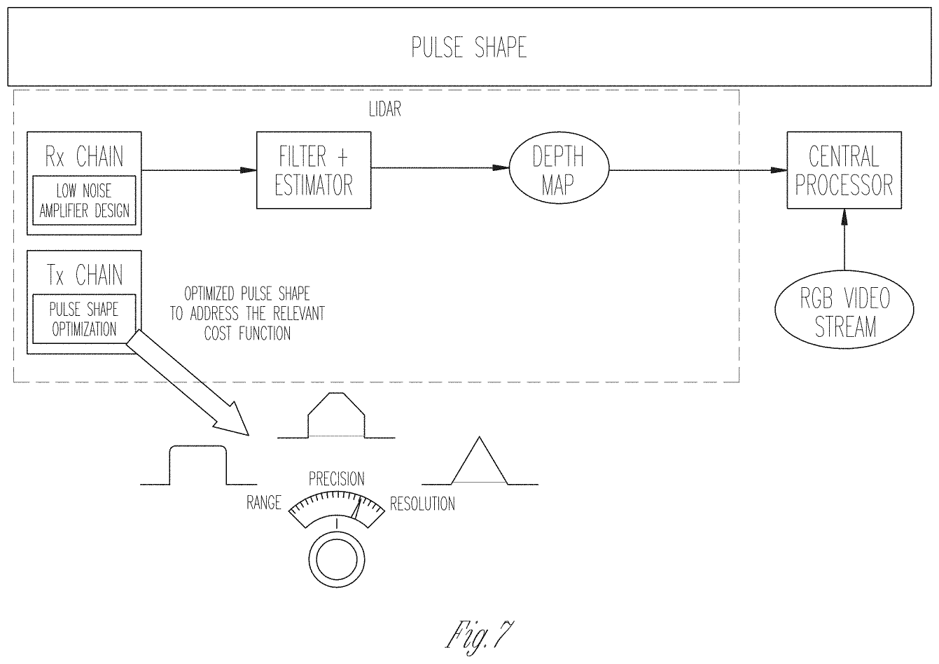

FIG. 6 depicts the block diagram shown in FIG. 5, with the addition of low noise amplifier design improvements to the receive chain (Rx chain).

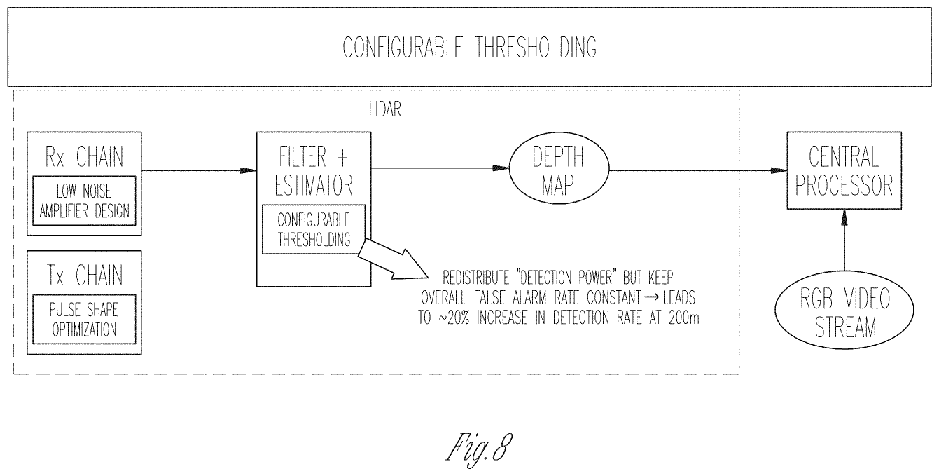

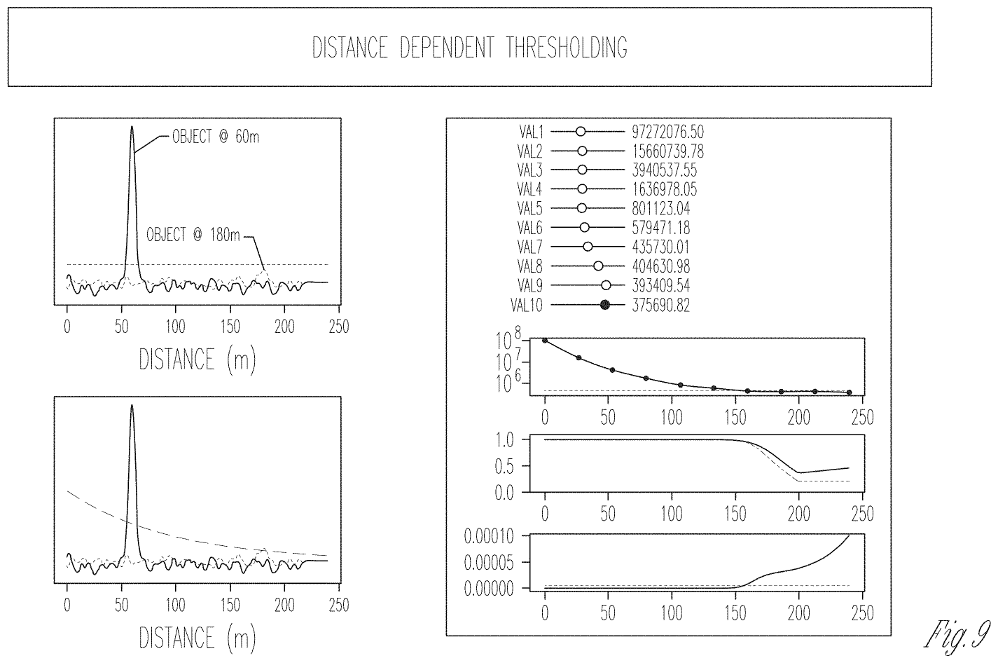

FIG. 7 depicts the block diagram shown in FIG. 5, with the addition of pulse shape optimization within the transmit chain (Tx Chain). For example, by using various techniques, the transmitter can generate a light pulse for transmission that has an optical intensity profile that includes a waveform having one or more relatively narrower pulses superimposed upon a relatively wider pulse. Thus, a hybrid pulse can be generated that includes both a wide pulse and a narrow pulse train portion, for example, superimposed thereon.

Noise in a LIDAR system can have various sources and some LIDAR system noise sources can be frequency dependent. For example, a transimpedance amplifier can be coupled to a photodetector to amplify an electrical signal based on the optical return LIDAR signal detected by and transduced into an electrical signal by the photodetector. Such a transimpedance amplifier can have a noise characteristic that increases with frequency, such that the transimpedance amplifier can be noisier at higher frequencies.

To accommodate such a transimpedance amplifier noise characteristic, a wider LIDAR transmit pulse can be used, having more energy concentrated at lower frequencies than a narrower LIDAR transmit pulse. But accurately determining a time-of-flight of the return LIDAR signal can be best accomplished using a narrower LIDAR transmit pulse, which has more energy concentrated at higher frequencies, at which the transimpedance amplifier can be noisy. For example, multiple narrow pulses can be combined close to one another to form a pulse train, e.g., where the time delay between the pulses in the pulse train is equal to or less than the time-of-flight for a pulse reflected by an object at the farthest distance measured. For interference mitigation purposes, the narrow pulses, e.g., forming a pulse train, can be encoded as a sequence.

Additionally, more distant objects are more easily detected using higher energy LIDAR transmit pulses, for example, wider or higher amplitude LIDAR transmit pulses. In a LIDAR system, range accuracy can be more important for closer objects than for distant objects.

For distant objects, the wide pulse portion of the hybrid pulse of this disclosure can maximize detection range because high frequency noise can be filtered out without removing the low-frequency content contained in the wide pulse signal. For objects at closer range and with adequate signal-to-noise ratio (SNR), the narrow pulse portion of the hybrid pulse of this disclosure can be detectable above the noise floor, which can yield good range resolution and precision.

Additional information regarding pulse shape optimization can be found in U.S. patent application Ser. No. 16/270,055 , titled “OPTICAL CODING IN A LIDAR SYSTEM” to Ronald A. Kapusta et al., filed on Feb. 7, 2019, the entire contents of which being incorporated herein by reference.

The Rx Chain of a LIDAR system may detect the reflected illumination using thresholding. Received energy that exceeds a specified energy threshold is deemed to be energy from the Tx Chain reflected by an object. Noise in the received signal is a concern. False alarms occur when there is in reality no object, but the received energy signal exceeds the specified energy threshold due to noise. Misdetection by the Rx Chain occurs when an object is present, but the received energy signal does not satisfy the specified energy threshold dues to noise.

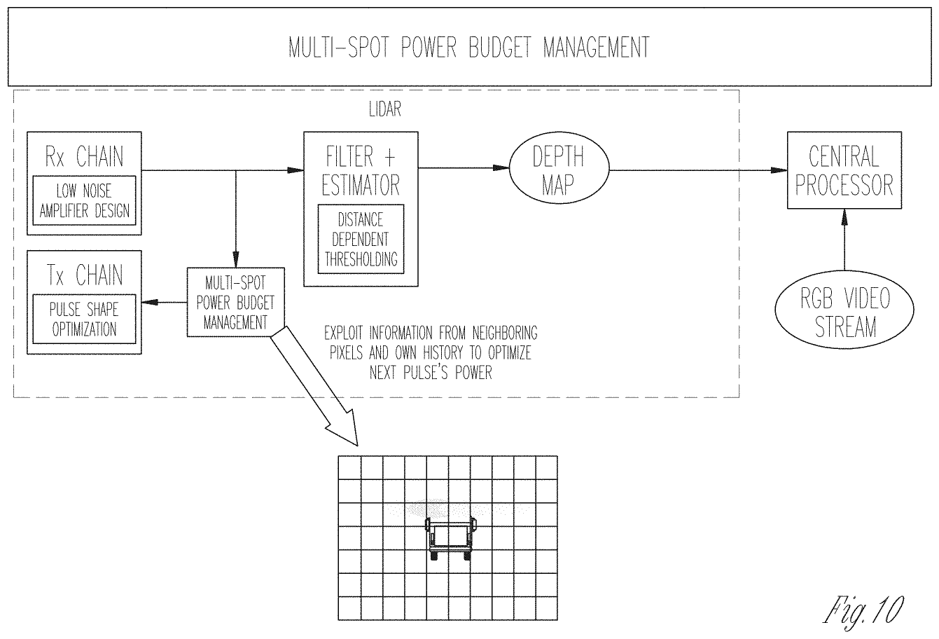

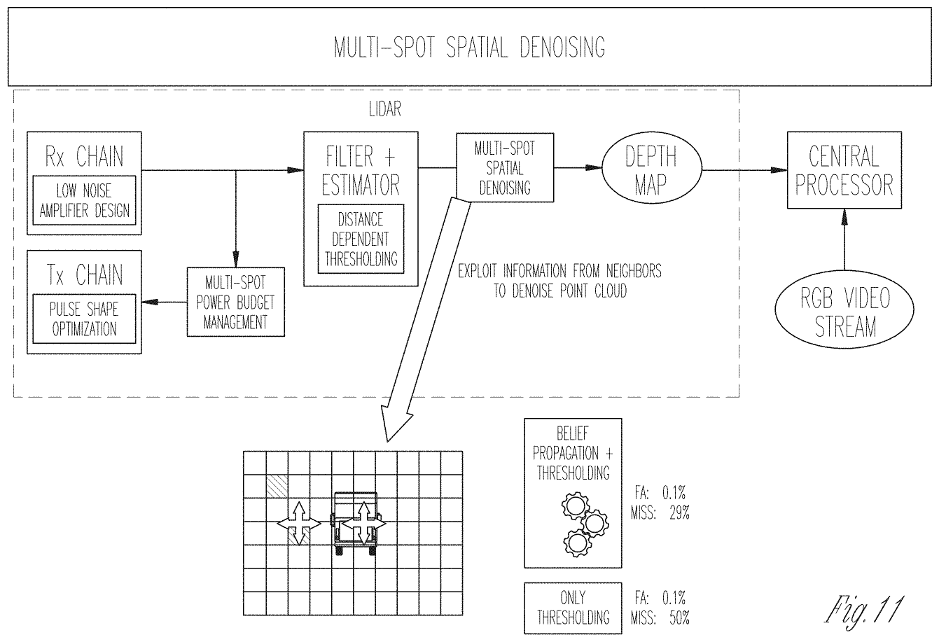

FIG. 8 shows an example of using configurable thresholding in the receive chain. The threshold can be a threshold amplitude, or a threshold power, for detection of a returned pulse used to determine arrival of the pulse after a transmit time. This can be used to redistribute “detection power” while maintaining a specified false alarm rate due to noise, such as can yield about a 20% increase in detection rate at a distance of 200 meters. In an example, the configurable thresholding can be made distance dependent, such as shown in FIG. 9, in which the constant threshold shown by the dashed-line in the top graph of amplitude vs. distance can be replaced by a distance-dependent threshold that can have a higher threshold value at closer distances, and can decrease to a lower threshold value at farther distances, either monotonically or otherwise. In an example, the distance-dependent threshold can decrease as 1/(distance)². In another example, the distance-dependent threshold can decrease as a piece-wise constant function. In the context of LIDAR, in which arrival time corresponds to distance, this distance-dependent threshold can constitute an arrival-time dependent threshold. The distance dependent threshold can be applied to a time series of samples of the reflected LIDAR energy received at the receive signal chain. The time series of samples may be stored in memory, and the distance dependent threshold can be applied to the time series of samples stored in memory. In other aspects, the distance dependent threshold can be applied in real time as the samples of LIDAR measurements are received. Using a distance-dependent threshold can help increase or optimize signal detection ability over varying distances while preserving a desired specified or constant false alarm rate due to spurious noise in the LIDAR return signal.

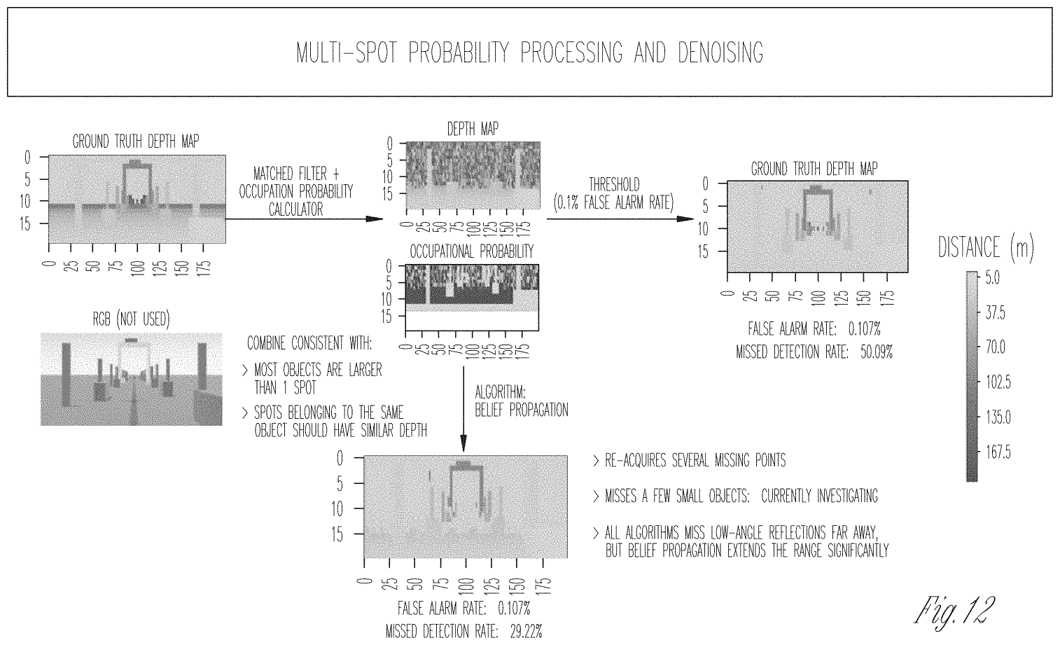

FIG. 10 shows an example of multi-spot power budget management. In scanning a frame of pixels, a particular spot in the scan may include some information about one or more adjacent pixels in the scan pattern. For example, a preceding pixel in the scan pattern may provide some information that can be used to control a power level or other characteristic the transmission of the LIDAR pulse in the subsequent pixel in the scan of the same frame of pixels. Furthermore, the time series of scanned frames of pixels can provide a pixel-by-pixel time-series of data corresponding to a particular pixel, such that information about the pixel from one or more previous frames can be used to control a power level or other characteristic of one or more subsequent LIDAR pulses issued for the same (or adjacent or nearby) pixels. Information about a pixel yielded by another pixel in the same frame can also be combined with information about that particular pixel yielded by the same pixel or other nearby pixels in earlier frames, such as to control the power level or other characteristic of the transmission of the LIDAR pulse for the particular pixel.

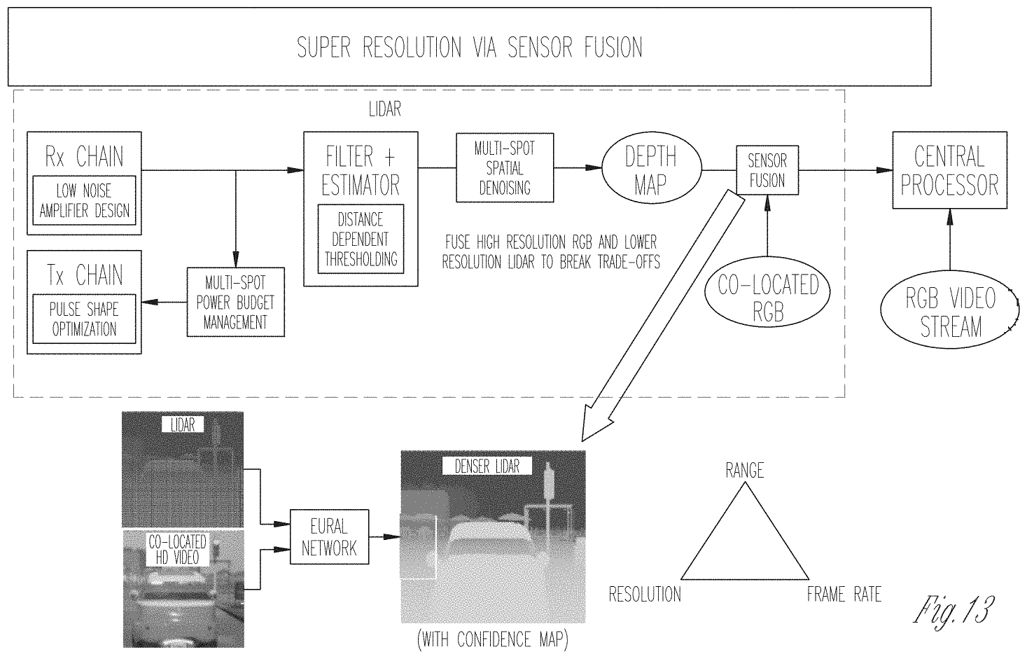

FIG. 11 shows an example of multi-spot spatial denoising, such as can be included in the receive chain of the LIDAR system. For a given frame of scanned pixels, individual pixels indicating the presence of an object that are not surrounded by adjacent pixels yielding the same or similar results, can be considered to be more likely to be noise-triggered, rather than a result of an actual object being present in a return LIDAR image. That is, actual objects are more likely to return more than a single isolated pixel indication of their presence. In this way, using information about adjacent pixels in the frame, the point-cloud can be denoised to remove individual isolated pixels from the point cloud in the return LIDAR signal. Velocity information for a particular pixel can additionally or alternatively be used for similar denoising of the point cloud.

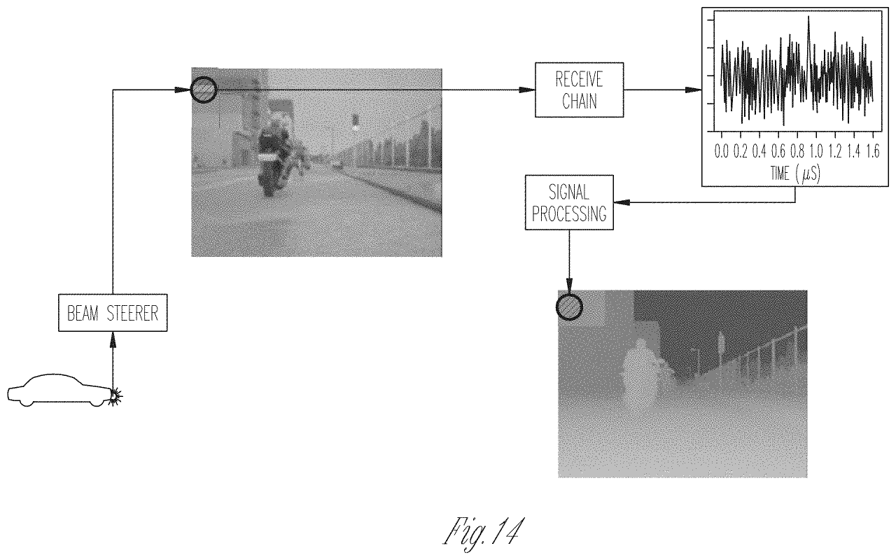

FIG. 12 shows a more detailed example of multi-spot probability processing and denoising. On the left side of FIG. 12, an RGB or other video image of an environment is shown, above which is presented a corresponding “ground truth” depth map, such as can be represented by a LIDAR return signal. The LIDAR measurement data can represent a three-dimensional (3D) space in the LIDAR systems field of view. The 3D space consists of volume elements or voxels. One frame of LIDAR measurement data represents one measurement sample of the 3D space in time. Multiple frames represent multiple measurement samples of the 3D space over time. By applying a matched filter and an occupation probability calculator to one or more frames of a LIDAR return signal, a separate depth map and occupation probability map can be generated. The depth map indicates the distance-to-object of the LIDAR return signal.

The occupation probability map can use multi-spot probability processing and denoising, such as described above with respect to FIG. 11, such as to indicate whether an object is present at a particular voxel. The occupation probability map can be input to a Belief Propagation or other like algorithm, such as can be applied to a depth map to generate a resulting output frame with an improved missed detection rate (e.g., 29.22%), as compared to a missed detection rate (e.g., 50.09%) of an output frame generated without using the generated occupational probability map processed via the belief propagation algorithm, while maintaining a like false alarm rate. Using the depth map and occupation probability map, the processing circuitry can interpret the depth information and probability information to generate an indication of presence of an object in the field of view of the LIDAR system. This indication may be used by an autonomous vehicle to make navigation decisions.

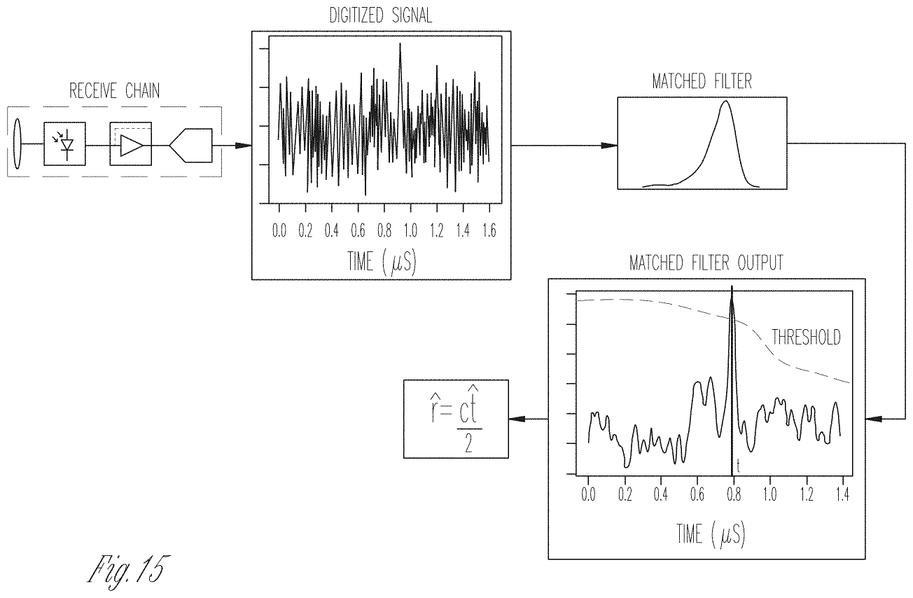

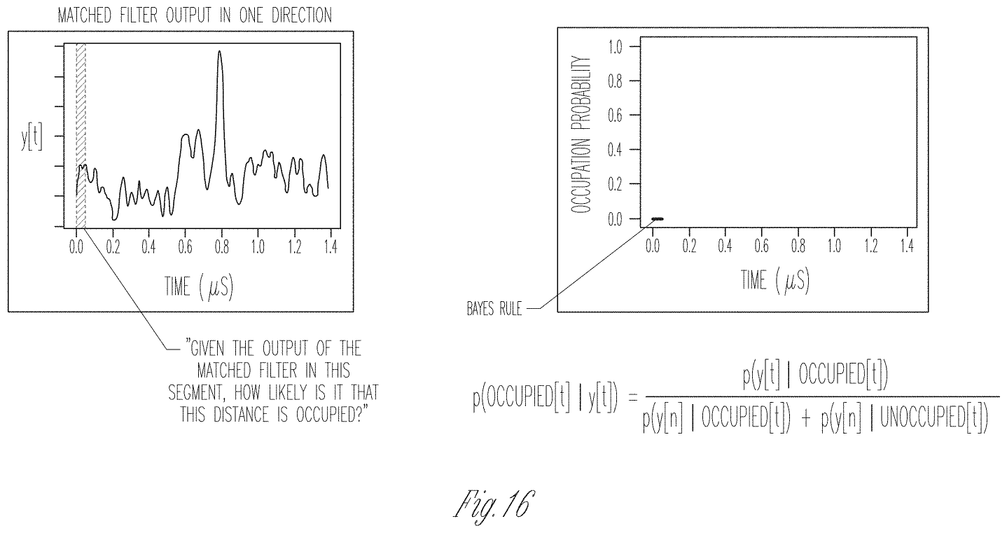

FIG. 13 shows an example of a sensor fusion technique in which one or more additional sensors, e.g., RGB sensing, can be included in a LIDAR system to improve resolution to break the tradeoffs between range, resolution, and frame rate. Although shown as a co-located RGB sensor, the techniques of this disclosure are not so limited.

The LIDAR image can be improved by using the LIDAR system sensors in combination with one or more additional sensors. For example, the LIDAR image can be improved by fusing information from the LIDAR sensor and information from a high resolution RGB sensor, such as a high resolution RGB video camera, e.g., high frame rate video camera. Examples of sensor fusion algorithms that can be used to perform the fusion of the LIDAR sensor information and the RGB sensor information include, but are not limited to, neural networks, machine learning, bilateral filtering, e.g., guided bilateral filtering, guided filters, Belief Propagation algorithms, and interpolation.

Other sensors that can be used can in addition to or instead of RGB sensors can include radar and/or infrared (IR) sensors.

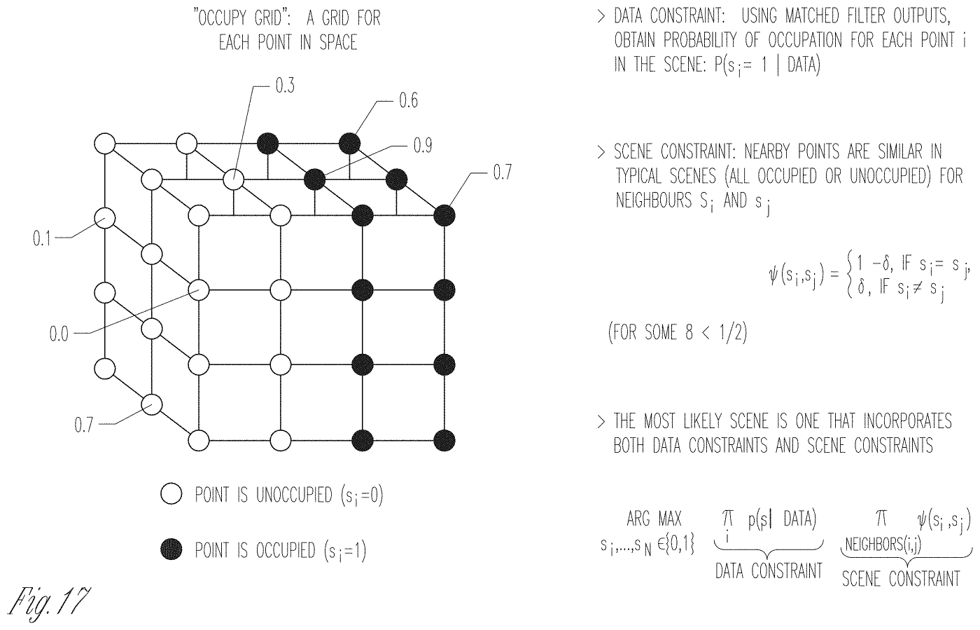

FIG. 14 is a conceptual diagram depicting a LIDAR system. A beam steerer in a transmit chain can direct light pulse(s) toward a target region. Light scattered or reflected by a target or object in the target region in response to the transmitted light pulse can be received via a receiver signal. Signal processing can be performed on the receiver signal to determine a distance to the target or object, for example.

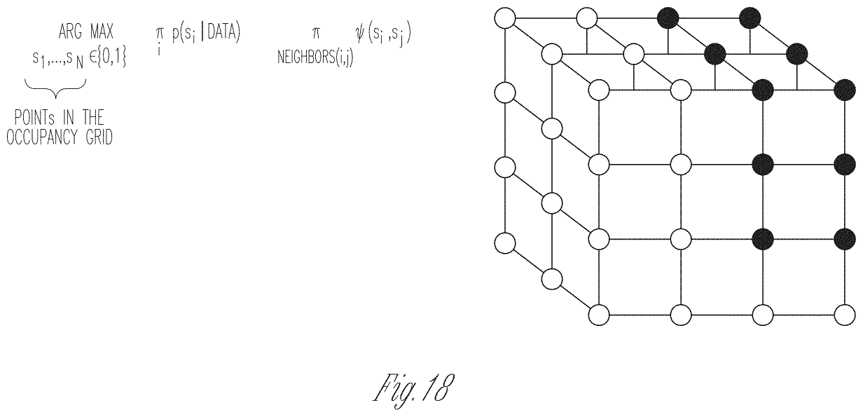

FIG. 15 is a conceptual diagram of a signal processing chain. An example of a receive chain can include a photodiode, an amplifier, e.g., a transimpedance amplifier, coupled to the photodiode, and an analog-to-digital converter (ADC) circuit coupled to the output of the amplifier. The signal processing chain can include a matched filter. For example, a pulse detection circuit can receive a digital reference signal corresponding to the transmitted light pulse and can search the received digitized signal to find a signal corresponding to the digital reference signal using a matched filter. A threshold can be applied to the output of the matched filter to determine whether a pulse has been received in response to the transmitted light pulse. As shown in FIG. 15, the threshold may be varied with time. If an intensity equals or exceeds the threshold, then a circuit of the receive chain can determine that a light pulse was received.

As mentioned above with respect to FIGS. 11 and 12, multi-spot probability processing and denoising techniques can be included in the receive chain of the LIDAR system. These techniques serve to denoise a scene, which allows for lower thresholds applied on sensor data and increased ability to detect the presence of objects in space while still keeping the false alarm rate at acceptable levels. Additional multi-spot processing techniques are described below with respect to FIGS. 16-23 that use Belief Propagation algorithms to denoise point clouds or depth maps.

Two additional multi-spot processing techniques are described, which can be considered as complementary. Belief Propagation (BP) on the occupation grid can be an alternative to the multi-spot denoising technique described above with respect to FIGS. 11 and 12, and the median filter technique can be used either separately or in conjunction with either of the BP techniques.

An “occupancy grid” can include a number of points that can he voxels. Each point or voxel on the grid i refers to a point in three-dimensional space (see FIG. 17) of a target region for the imaging, and for each point, there is a binary variable sᵢ, where sᵢ=0 if the point is occupied and 1 otherwise. Each point or voxel includes a characteristic or property used to judge occupancy of the point or voxel. The LIDAR measurement data is converted to the characteristic. An example of a characteristic is probability of occupancy. From the matched filter outputs for each spot (e.g., direction) in a frame, the signal processing chain can compute the probability that each point in the occupation grid is occupied. That is, the signal processing chain can compute the probability that sᵢ=1 for each point i in space.

An example of a computation of probability of occupancy as the characteristic is shown on FIG. 16 for any given direction of space. The computation involves application of Bayes' rule with suitable assumptions on prior probabilities. If this process is applied to each point in space, the result is p(sᵢ=1 data) for all i in space. In some example implementations, the statistics of the matched filter output used for the Bayes rule computation can be calculated by offline simulation.

In some example implementations, scene constraints can be introduced by specifying that nearby points or nearby voxels in space are correlated. Whether points or voxels are “nearby” can be defined as a specified distance from each other, such as immediately adjacent or within a number of points or voxels away. For example, a function can be introduced that, for any two neighboring points i and j in the occupancy grid, is large (e.g., greater than ½) for the case sᵢ=sⱼ and small (e.g., less than ½) otherwise. The ratio between the “large” and “small” values can be a measure of how much nearby points can be biased to be similar. This function can be referred to as the scene potential function.

An example of a “best” scene can be one that maximizes the product of the most likely occupation states conditioned on the data (e.g., probability data) and the product over neighbors of the grid of the scene potential. The mathematical cost criterion is shown at the end of FIG. 17 that maximizes the product of the data constraint and the scene constraint. As shown in FIG. 18, this can be computationally demanding to calculate directly.

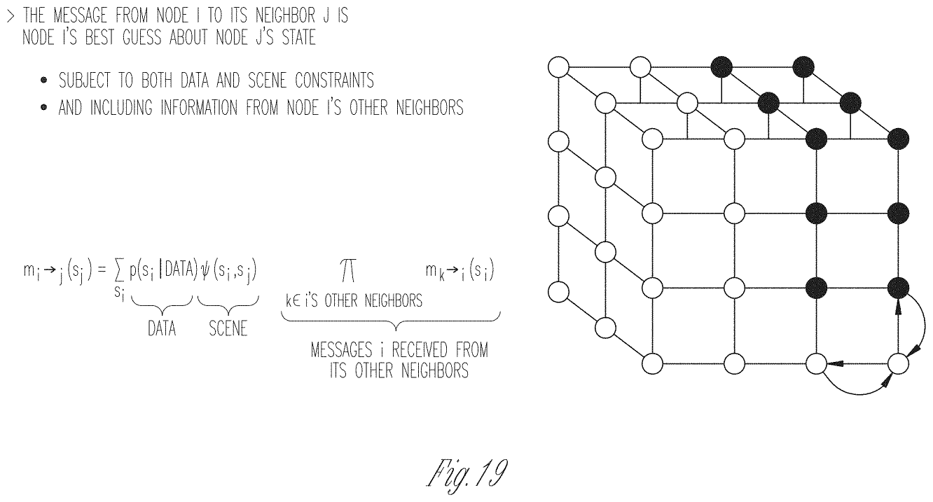

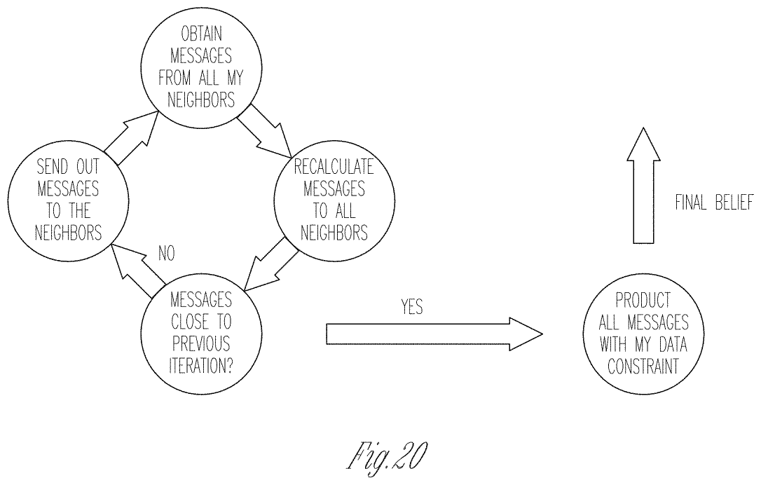

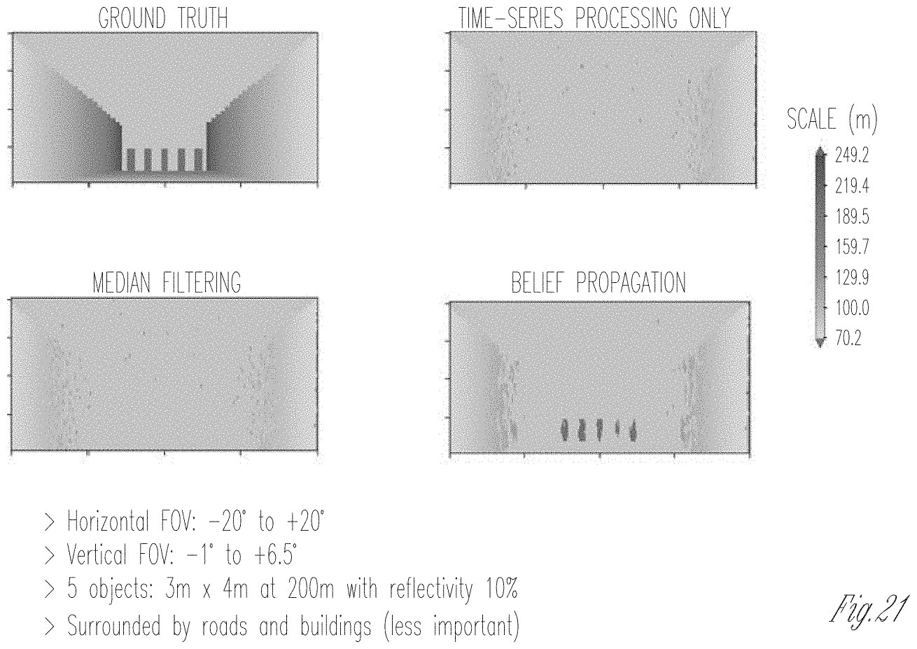

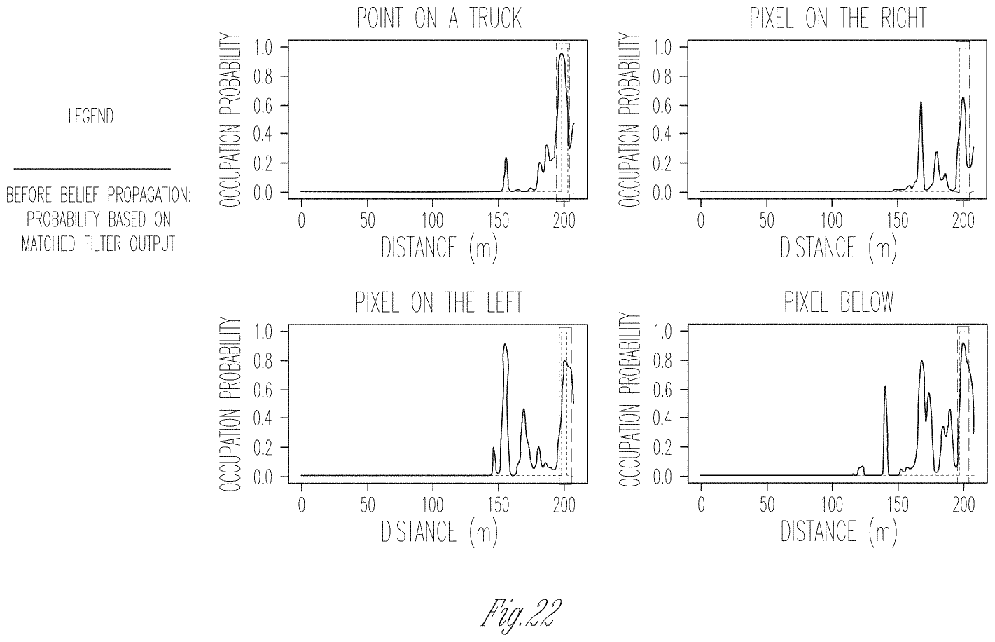

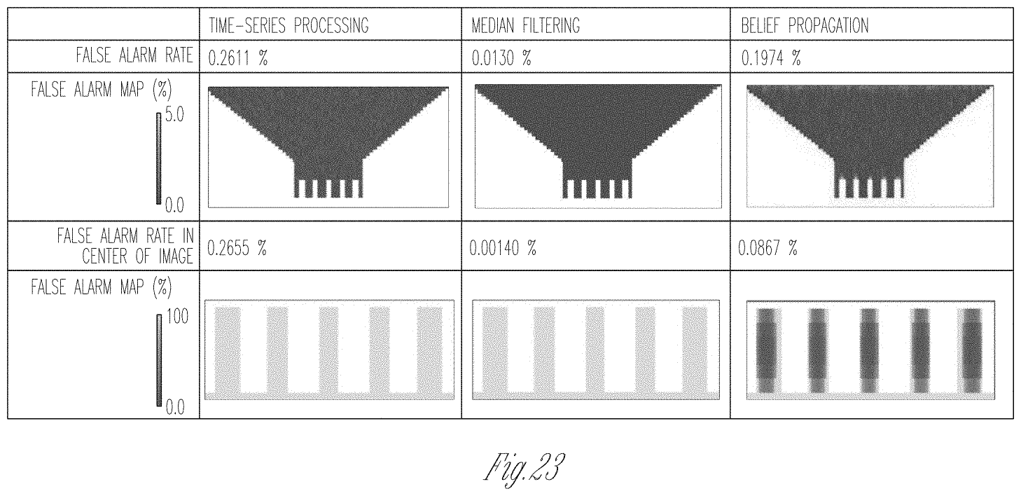

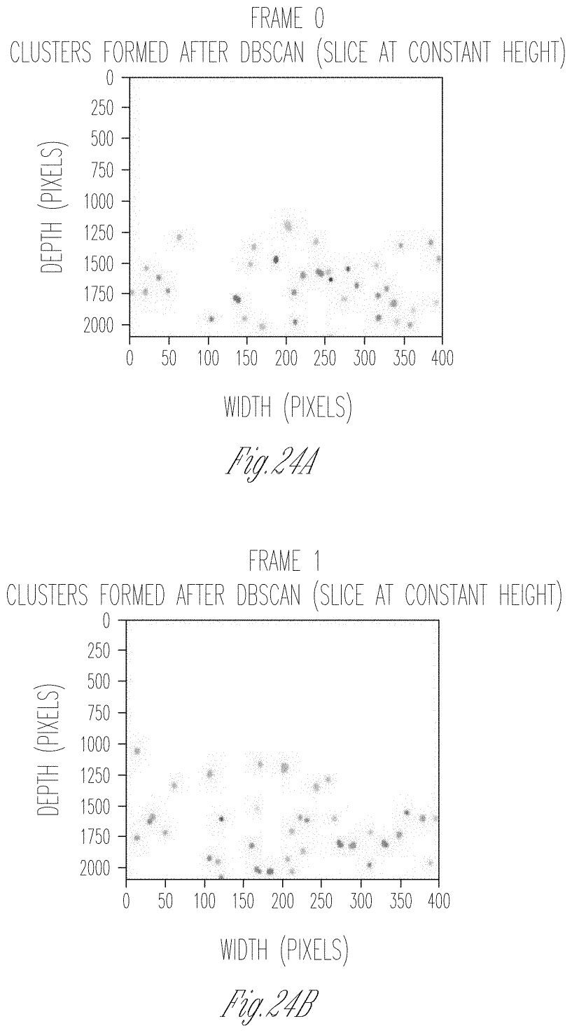

As a surrogate to solving the optimization problem of FIG. 18, the Belief Propagation algorithm can be utilized. Essentially, every point or voxel in space can send or pass a message to each of its neighbors or the point or voxels within a specified distance, as described in FIG. 19. The message sent by a point or voxel can include a guess or estimate of the value of the characteristic of the neighbor's point or voxel. The receiving point or voxel can recalculate its characteristic using the received characteristic. The receiving point or voxel can also recalculate the estimate of the characteristic of neighbor voxels. This recalculated characteristic can be sent during the next message sending. Thus, the recalculated characteristics propagate in the 3D space. The message passing and adjustment to the characteristics can continue until messages converge, as shown in FIG. 20. The messages may be deemed to have converged after a specified number of iterations of message passing and recalculation, or the messages may be deemed to have converge when the recalculations of the characteristics change the value of the characteristics by less than a predetermined change or delta. Finally, for each i the signal processing chain can output the product of all neighbors' messages *p(sᵢ=1 data). As explained previously herein, the characteristic may be probability data representing a probability that the point or voxel is occupied by the object. Other statistics can be used and the computations adjusted accordingly. For example, likelihood ratio may be used for the voxel characteristic. Likelihood ratio is a ratio including a probability that a voxel is occupied by the object and a probability that the voxel is not occupied by the object.

The final beliefs or adjusted characteristics can be combined with the matched filter output. For example, all final beliefs can be thresholded with some required occupation probability to declare a detection at each point and then the maximum of the matched filter output within each detection window can be used as an estimate of range.

In some example implementations, the computations can be simplified without significantly affecting performance by discarding all cases where the message is known to be very strong in either direction. For example, message passing for regions of the grid where the messages are all reinforcing the belief that the point is occupied or that the point is unoccupied may not be needed. Rather, message passing may be used only for regions of the grid where there is ambiguity in the occupation state.

Median filtering is a technique used in image processing that applies a kernel, e.g., a 3×3 kernel, and within each kernel, replaces the pixel at the center of the kernel with the median value of the pixels in that kernel. In accordance with this disclosure, a signal processing chain can apply a median filter on the occupation probability data. In other words, the signal processing chain can calculate an occupation probability for each direction.

For example, the signal processing chain can take the final beliefs at the output of the Belief Propagation, determine which distance to report in each direction, and use the belief at that distance as the occupation probability for that direction. In addition, the signal processing chain can use the input data probabilities (before running BP), choose a distance to report (including possibly no distance)and use the occupation probability at that distance in that direction as the occupation probability for that direction. Once the signal processing chain has determined a probability per “spot”, the signal processing chain can apply a median filter. The median filtering can be effective in reducing or eliminating false alarms.

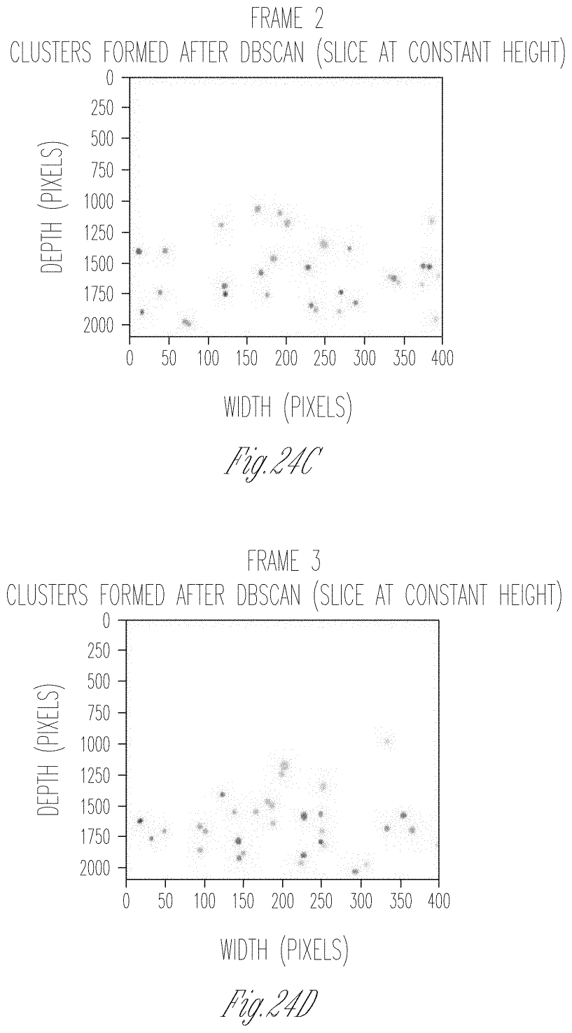

FIG. 21 shows a comparison of performance for various algorithms in detecting 5 distant objects having low reflectivity. As seen, the Belief Propagation techniques were able to detect the objects, which were missed by other methods.

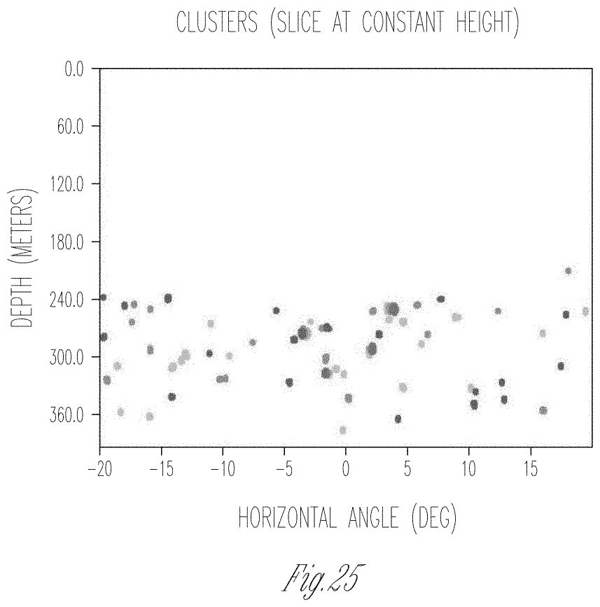

FIG. 22 shows how the beliefs converge using the Belief Propagation techniques described above. In particular, FIG. 22 shows that for four (4) adjacent points in space that initially have uncertain beliefs around an object at 200 m, the Belief Propagation can converge to a high occupation probability state for all four. At the same time, other uncertain points (e.g., near 150 m) on the bottom left plot that do not agree with the neighbors get rejected as false alarms.

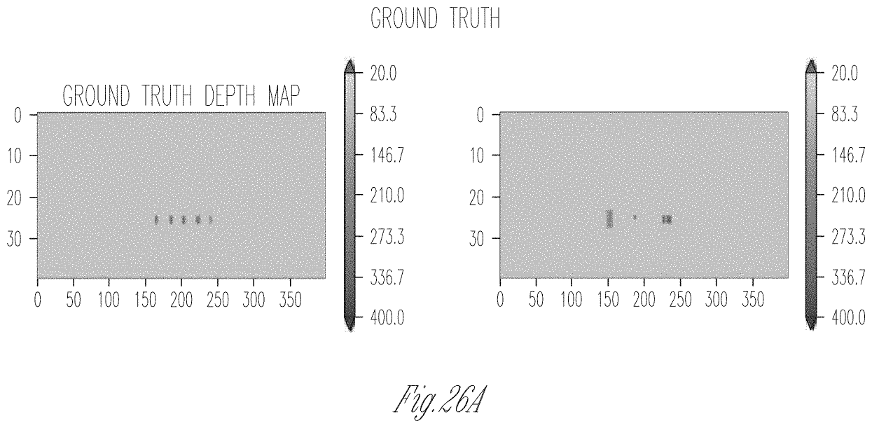

FIG. 23 shows numerical results using the Belief Propagation techniques described above. FIG. 23 shows a map of false alarm rates for various points on a scene and a map of misdetection rates near the center of the image for the 5 distant objects of FIG. 21. Also included are the overall false alarm rates for the various algorithms.

Different signal processing techniques can be applied to different regions of the 3D Space. For example, the 3D space may be divided into subsets of points or voxels. For some subsets, belief propagation can be applied the voxels of one more of the subsets to determine occupancy of the voxels using information regarding the characteristics from nearby voxels. For other subsets, comparison to a threshold characteristic may by used to determine occupancy. One approach to dividing a 3D space into subsets, is to divide the 3D space by distance away from the LIDAR sensor or LIDAR system. Voxels less than a specified distance from the LIDAR system may be deemed close enough to not need more complicated signal processing such as Belief Propagation. For example, voxels that are close (e.g., 0 to 50 meters) may be processed with thresholding while voxels far away (e.g., 100 to 150 meters) may be processed using multi-spot processing and denoising.

Another approach to denoising the receive chain of a LIDAR system is eliminating peaks in the output of the matched filter output that do not conform to specific physical constraints. If the peaks correspond to real objects, the behavior of the peaks detected in the output will be constrained by behavior to which actual objects are constrained. Tracking of the peaks between outputs (e.g., between frames of the scene or field of view) is used to improve and refine detection of real objects. It should be noted that this is different from using a complicated detection scheme to identify an object and then track that identified object in the field of view. Here, suspected or candidate objects are tracked in an environment that may be noisy to identify the candidate objects as real objects or noise.

The detection method detects objects in the field of view by applying physical constraints to detected objects to discern actual objects from noise. For example, if the detected object is a car, the detected movement of the car will have a substantially constant velocity practical for cars, or no velocity for stationary objects on the road. While it is true that a car moving on the road might have some acceleration that would violate the velocity constraint, it should be noted that the LIDAR receiver is getting images at some reasonable frame-rate such as 10 frames a second. For an object accelerating from 0 to 60 in 2 seconds, (which is the slighter faster than what cars can do today) the object will move approximately ⅕ of a voxel each frame in the far-field regime. This amount is so small that the acceleration can effectively be treated as noise.

In general, the detection technique includes analysis of consecutive frames of the field of view, or portion of the field of view, to determine if a candidate object is present or if the candidate object is really noise and not an object. The analysis can be performed by processing circuitry (e.g., one or more digital signal processors or DSPs) that processes the data received from one or more LIDAR receive chains.

A real object that is not noise would move around in a more confined trajectory than noisy points. The detection technique uses basic behavior constraints from physics of a moving vehicle to determine whether a sequence of signals is an object or noise. The description that follows begins with description of a mathematical problem that can be adjusted to the LIDAR application of identifying objects.

The mathematical problem includes a process that can be referred to as a “Firefly Process” to describe how real objects can be discerned from noise in an image. Assume there is a rectangular three-dimensional (3D) space with dimensions L=(Lₓ, L_{y}, L_{z}) where Lₓ corresponds to the width, L_{y} corresponds to the height, and L_{z} corresponds to the depth. In this space, assume there are moving fireflies that flash light and that also move with constant velocity.

At each time frame i, all the flashes that occur in the 3D scene are recorded. This results in a list of points of positions of flashes. However, there are two types of noise that prevent immediately detecting where the fireflies are: 1) the positions of the firefly flashes have noise due to the recording system, and 2) there are ambient flashes which do not correspond to any fireflies. Noise in the firefly position can be modeled as Gaussian noise with mean zero and variance σ² in each dimension. Hence, the firefly noise is independent of position.

The ambient flashes that are not fireflies can be modeled as a Poisson distribution with parameter λ given over volume (or any other process which creates some number of points independently and uniformly in space and some density parameter λ). In practice, these represent noise points where the matched filter output registered a signal that could be confused with a true signal from a moving object. The distribution of the noise points is modeled as Poisson random variables because that makes the noise points and the ambient flashes independent and uniform in space. The goal is to be able to determine which flashes are due to fireflies and which are due to ambient noise. In particular, after analysis of frames 1, . . . , n, the goal is to detect which flashes in the most recent frame are from fireflies. It is assumed that there could be any number of fireflies (including zero) in the scene.

For the LIDAR problem, the fireflies of the firefly process correspond to moving objects on the road. The noisy flashes in a frame represent noise points or voxels where the signal processing of the receive channel registered a signal that could be confused with a true signal from a moving object. Noise in the position of the object is a result of the processing required to transform the LIDAR measurement into a representative center point of the object.

In the object detection technique, it is first considered how to hypothesize whether a sequence of points is from an object or from noise before the analysis is presented of how to infer where the objects are located in the whole scene.

Suppose first that there is only one point appearing in each frame and that we know that either all points are from objects or all points are from ambient noise, The points are denoted as y₁, y₂, . . . , yₙ which respectively occur in frames at times t₁, t₂, . . . , tₙ. It can be inferred whether this trail corresponds to an object or to noise by using Heyman-Pearson Hypothesis testing. Unfortunately, if the trail of points is from an object, the actual positions and velocities are not known to determine the probability of observing the trail. Because of this, the Generalized Likelihood Ratio test is used in which the values of initial position and velocity of the trail lead to the largest likelihood.

Assuming the trail of points is from an object, the probability of the object position is maximized by using the estimate for velocity and some initial position given by minimizing ordinary least squares. Let \hat{β}₁ represent our estimate for velocity and let \hat{β}₀ represent our initial position arbitrarily chosen to occur at time 0. This results in the estimate for the position of the object at frame i as \hat{β}₀+\hat{β}ₜ.

This minimization to these parameters is given by

$${\hat{β}}_{1} , {\hat{β}}_{0} = arg {min}_{{β}_{1} , {β}_{0}} {\sum }_{i = 1}^{n} {\vert {y}_{i} - ( {β}_{0} + {β}_{1} {t}_{i} ) \vert}^{2} ,$$

where n is a number of consecutive frames held in a buffer.

Assuming n≥2 the least squares optimization can be computed. This computation gives

$${\hat{β}}_{i} = \frac{n {\sum }_{i = 1}^{n} {t}_{i} {y}_{i} - {\sum }_{i = 0}^{n} {t}_{i} {\sum }_{i = 1}^{n} {y}_{i}}{n {\sum }_{i = 1}^{n} {t}_{i}^{2} - {( {\sum }_{i = 1}^{n} {t}_{i} )}^{2}} \\ {\hat{β}}_{0} = \frac{{\sum }_{i = 1}^{n} {t}_{i}^{2} {\sum }_{i = 0}^{n} {y}_{i} - {\sum }_{i = 0}^{n} {t}_{i} {\sum }_{i = 1}^{n} {t}_{i} {y}_{i}}{n {\sum }_{i = 1}^{n} {t}_{i}^{2} - {( {\sum }_{i = 1}^{n} {t}_{i} )}^{2}}$$

The expression above can be simplified. If the variables tᵢ are adjusted by subtracting a constant, by taking \tilde{t}ᵢ=tᵢ−c so that Σᵢ₌₁ⁿ\tilde{t}ᵢ=0, the expressions above simplify to

$${\hat{β}}_{1} = \frac{{\sum }_{i = 1}^{n} {\tilde{t}}_{i} {y}_{i}}{{\sum }_{i = 1}^{n} {\tilde{t}}_{i}^{2}}$$

$${\hat{β}}_{1} = \frac{1}{n} {\sum }_{i = 1}^{n} {y}_{i}$$

The above equations state that in view of the distribution of the empirical data, the best estimate of velocity is covariance of yᵢ and \tilde{t}ᵢ divided by the variance of \tilde{t}ᵢ and the initial position is the expected value of yᵢ. For the rest of the analysis, tᵢ will be used to mean \tilde{t}ᵢ since the shift is not consequential.

In vector notation,

$$Y = {[ \begin{matrix}{y}_{1} , & {y}_{2} , & … , & {y}_{n}\end{matrix} ]}^{T}$$

$$X = {[ \begin{matrix}1 & 1 & … & 1 \\ {t}_{1} & {t}_{2} & … & {t}_{n}\end{matrix} ]}^{T}$$

$$and$$

$$β = [ \begin{matrix}{β}_{0} \\ {β}_{1}\end{matrix} ] .$$

Then the probability is

$$ℙ [ Y = ( {y}_{1} , … , {y}_{n} ) \vert β = \hat{β} ] = \frac{1}{{( 2 π σ )}^{n / 2}} exp ( - \frac{{\vert X \hat{β} - Y \vert}^{2}}{2 {σ}^{2}} ) .$$

If all the points are from ambient noise, the probability of each point occurring at a position in space is uniform and each frame is independent from another. The sequence of points occurs with uniform probability (p) under the ambient noise hypothesis. Therefore, in order to perform a generalized hypothesis test, it is needed only to determine L(X, Y) where

$$L ( Y , X ) = log \frac{p}{\frac{1}{{( 2 π σ )}^{n / 2}} exp ( - \frac{{\vert X \hat{β} - Y \vert}^{2}}{2 {σ}^{2}} )}$$

Comparing L(Y,X) to a threshold is equivalent to comparing |X\hat{β}-Y|²to a threshold. Thus, to distinguish between an object and noise, it is only necessary to compare |X\hat{β}-Y|² to some threshold.

The comparison to the threshold can be used to control the probability that independently and uniformly generated noise contains a sequence of points that would pass being interpreted as an object. The threshold is denoted as η. A sequence of noise points Y will pass as an object if

|X\hat{β}-Y|²≤η.

By choosing a suitable value of η, the rates of false detections and true acceptances can be tailored for the implementation.

The proposed methods for object detection follow the idea of the Firefly Process while minimizing the computation time. The basic steps of the method are:
1. Preprocess output of the LIDAR receiver into clusters.
2. Search for sequences of three clusters that meet the behavior constraints, which correspond to the comparison above.
3. Extend clusters sequences (if needed to reduce false alarms).

A cluster is comprised of candidate voxels that are candidates for being occupied by an object. For example, candidate voxels may be identified as voxels in a frame for which the matched filter output exceeds a specified threshold. Other characteristics can be used (e.g., probability data, likelihood ratio, etc.). A lenient threshold is set for inclusion of points as candidate points or voxels.

While the objects being detected are small, the objects may still have a height and width of a few voxels, and a depth of several voxels. Size and position constraints may be used to identify candidate voxels. For each frame, candidate voxels can be grouped together candidate clusters based on one or both of size and proximity to each other. Alternatively, candidate clusters can be identified by applying a clustering algorithm (e.g., DBSCAN) to the candidate voxels.

Candidate clusters in three or more consecutive frames are then analyzed to find sequences of three clusters that satisfy the behavior constraints. The justification for using three frames as a starting point is that it is the fewest number of frames required to distinguish an object from noise, and also requires the smallest amount of memory for storing and processing. Because it assumed that the object is not moving very far, all sequences of clusters in the three consecutive frames do not need to be searched, but only the sequences wherein the clusters are spatially close to one another.

For the case of three-point or three-voxel clusters, the behavior constraints are:
1. Velocity Constraint—This constraint forces two points of a cluster to be close to another in space. The interpretation is that objects cannot move very fast (since the speed of objects like cars is limited). This constraint sets a maximum speed.
2. Acceleration Constraint—The velocity of the object is computed between the first and second frame, the second and third frame, and the change in the velocity (or acceleration) between computations is found. Technically, the acceleration of the actual object should be zero based on our assumptions, but acceleration of noisy points will deviate from the zero assumption. It is assumed that the acceleration of noisy signals should be small and a bound for the acceleration is set. This corresponds to an interpretation that a sequence of points corresponding to a real object should not jitter too much. A constraint on acceleration also corresponds directly to a threshold on the log-likelihood in the Firefly Process.

As mentioned previously herein, the signal received at the LIDAR receiver after a laser pulse is sent out is first processed by a matched filter. To discriminate an object from noise, the matched filter output is processed into probabilities based on statistics collected about its distribution. The probabilities reflect the probability that a certain coordinate (e.g., a voxel) in point space is an object.

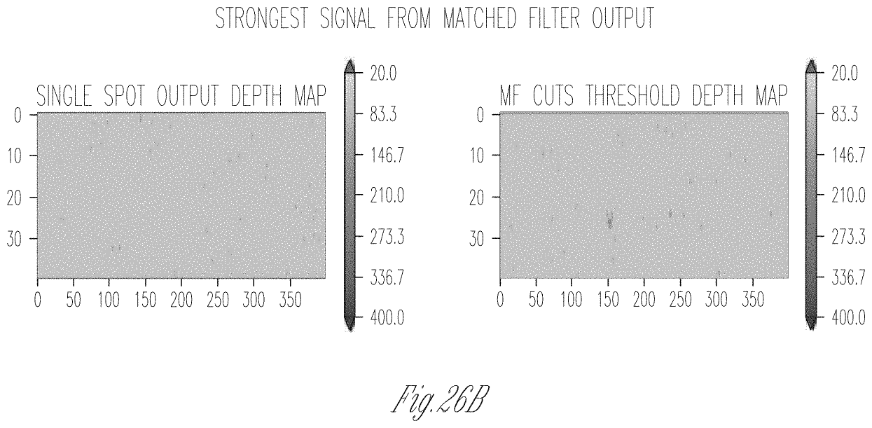

FIGS. 24A-24D shows the results of the preprocessing and clustering steps for four frames of LIDAR imaging. Each of the Figures shows a frame representing a slice of the field of view at a constant height. Each of the frames shows clusters identified in each frame. The position of each cluster may be represented by its center of mass, which can be identified as the average position in width, height, and depth of points or voxels included in the cluster.

The next step in the method is to search the frames for frame sequences containing the same cluster (cluster triples) because presence of the cluster in three consecutive frames means that the cluster likely corresponds to an object.

For each cluster in frame i, the corresponding clusters in frame i+1 are found that meet the velocity constraint. A cluster metric is used to test for similarities between clusters (based on factors like size, widths, and distance). The top matches (e.g., 5 matches) in frame i+1 that meet the velocity constraint and have the most similarity to the cluster in frame i are called candidates or candidate clusters. This is repeated to also find for each cluster in frame i+1 its possible candidates in frame i+2 to apply the acceleration constraint.

When frame i+2 is received, the clusters triples (A, B, C) are searched; where A is a cluster in frame i, B is a cluster in frame i+1 which is a candidate of A, and C is a cluster in frame i+2 which is a candidate of B. The identified cluster triples (A, B, C) are tested to see if the cluster triples meet the acceleration constraint. If the cluster triple meets the constraint, the cluster triple is stored in memory and labeled or otherwise identified in memory as being a cluster triple.

At this point, all the cluster information in frame i is cleared. The only clusters which will remain are those stored in memory as cluster triples.

FIG. 25 is an illustration of cluster triples identified in a frame. The progression of scenes is illustrated with the color variation in the Figure. The lightest clusters being the earliest scenes. It should be noted that by searching for triples using the velocity and acceleration constraints, almost all of the noise can be eliminated. Other constraints can be used such as the least squares optimization described previously herein, and a cluster shape constraint applied over frame i and frame i+1.

If too many false alarms or misdetections occur in the cluster triples, the concept can be extended to longer cluster sequences (e.g., a sequence of four clusters, or a sequence of five clusters). There may be multiple ways to accomplish implementing longer sequences, but a preferred approach would be one that does not require storing more data.

At this point in the analysis, there are cluster triples stored in memory that meet the acceleration constraint. Suppose the latest collection of cluster triples are from frames i, i+1, and i+2. To extend the concept to a sequence of four clusters, for every cluster triple stored, it can be checked to see if there is another cluster in a fourth frame (i+3) which is along its trajectory.

One approach to accomplish this is to apply the Firefly Process estimation directly and add a new cluster to the cluster triple if the sequence of four clusters creates a vector Y not so far from the span of X (e.g., |X\hat{β}-Y|² is small).

A second approach is to see if the new cluster in frame i+3 will satisfy the acceleration constraint with the clusters of the triple formed with frames i+2 and i+1. Thus, the acceleration constraint is applied over a three-frame window that moves through successive frames. This can be extended to see if the acceleration constraint is satisfied over the next three frames i+4, i+3, and i+2, and so on as desired. In the general case, the acceleration constraint is applied over frames i+k, i+(k−1), i+(k−2). This second approach involves less calculation than the first approach and yields satisfactory results in practice.

The velocity constraint can also be applied to a two-frame window that moves through successive frames. For example, after frame i and frame i+1 are tested using the velocity constraint, frames i+1 and i+2 are tested using the velocity constraint.

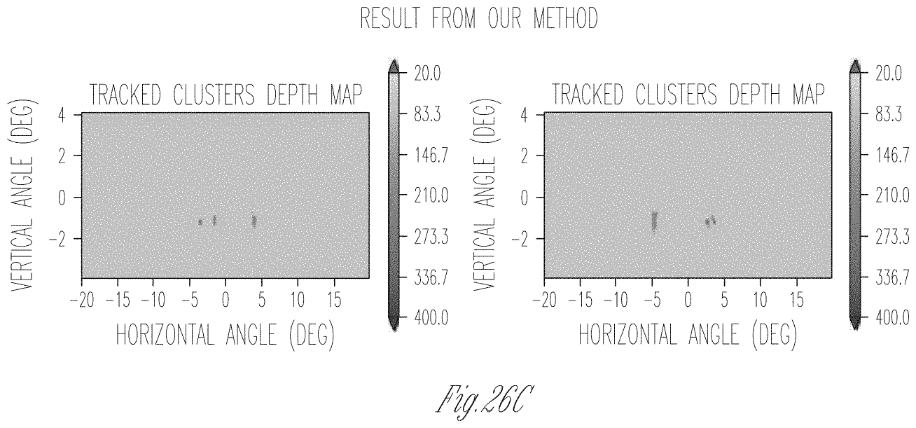

FIGS. 26A-C are plots of two scenarios simulated using a virtual environment to test the object detection method. In FIGS. 26A-C, the first scenario is represented by the plots on the left in the Figures and the second scenario is represented by the plots on the right in the Figures. In the first scenario, five boxes were presented on a level similar to where cars would be on the road. Each box was positioned at a different distance. In FIG. 26A, the plot on the left shows the objects in the image for the first scenario. The plot on the left in FIG. 26B takes the best points (strongest signal) from the Matched Filter. A threshold was set to only allow the strongest signals. None of these points correspond to actual objects. FIG. 26C on the left shows the results using the object detection method. The object detection method identified 3 of the 5 boxes or “cars” while most of the noise was removed.

In FIG. 26A, the plot on the right shows a second scenario, in which four randomly generated boxes are presented. In FIG. 26B, the plot on the right shows the strongest signals from the Matched Filter output. Only the box at the closest distance could be seen just by processing the Matched Filter output. However, in FIG. 26C, the plot on the right shows that the next two closest objects were detected using the object detection method.

The object detection method described herein improves LIDAR depth images by finding a way to processing small objects that are far away. The depth in which a LIDAR system can detect an object is improved.

### Additional Description and Aspects

A first Aspect (Aspect 1) can include subject matter (such as a Laser Imaging Detection and Ranging (LIDAR) system) comprising signal processing circuitry and a memory coupled to the signal processing circuitry and configured to store LIDAR measurement data obtained by the LIDAR system representative of a three-dimensional (3D) space in a field of view of the LIDAR system. The signal processing circuitry is configured to convert the LIDAR measurement data to a voxel characteristic of voxels of the 3D space, continue to process and adjust the voxel characteristics of all voxels in the 3D space, and generate an indication of presence of an object in the field of view according to the adjusted voxel characteristics.

In Aspect 2, the subject of matter of Aspect 1 optionally includes signal processing circuitry configured to convert the LIDAR measurement data to probability data as the voxel characteristic for the voxels, the probability data representing a probability that the object occupies the voxels; adjust the probability data of the first voxel using probability data of the other voxels within the specified distance of the first voxel; and generate the indication of presence of the object in the field of view according to the adjusted probability data of the voxels in the 3D space.

In Aspect 3, the subject matter of Aspect 2 optionally includes signal processing circuitry configured to recalculate the probability data of the first voxel using the probability data of the other voxels multiple times; compare the recalculated probability data of the first voxel and the other voxels to one or more specified probability thresholds; and identify the voxels of the 3D space occupied by the object using results of the comparison of the recalculated probability data.

In Aspect 4, the subject matter of one or any combination of Aspects 1-3 optionally includes signal processing circuitry convert the LIDAR measurement data to a likelihood ratio as the voxel characteristic for the voxels, wherein the likelihood ratio is a ratio including a probability that a voxel is occupied by the object and a probability that the voxel is not occupied by the object; adjust the likelihood ratio of the first voxel using the likelihood ratios of the other voxels within the specified distance of the first voxel; continue to adjust the likelihood ratios of all voxels in the 3D space; and generate the indication of presence of an object in the field of view according to the adjusted likelihood ratios.

In Aspect 5, the subject matter of Aspect 4 optionally includes signal processing circuitry configured to compare the likelihood ratios of the first voxel and the other voxels to one or more threshold likelihood ratios; and generate the indication of presence of an object in the field of view according to the comparisons of the likelihood ratios.

In Aspect 6, the subject matter of one or any combination of Aspects 1-5 optionally includes signal processing circuitry configured to determine, for each voxel of the 3D space, a predicted value of the voxel characteristic of other voxels within a specified distance thereof; adjust the voxel characteristic of individual voxels of the 3D space using predicted values of the voxel characteristic; and generate the indication of presence of an object in the field of view according to the adjusted voxel characteristics.

In Aspect 7, the subject matter of Aspect 6 optionally includes signal processing circuitry configured to repeat the determining of the predicted values of the voxel characteristic and the adjusting the voxel characteristic of individual voxels of the 3D space using the predicted values multiple times.

In Aspect 8, the subject matter of Aspect 7 optionally includes signal processing circuitry configured to apply median filtering to the adjusted voxel characteristics of the voxels of the 3D space, and generate the indication of presence of an object in the field of view according to the adjusted and filtered voxel characteristics.

In Aspect 9, the subject matter of one or any combination of Aspects 6-8 optionally includes signal processing circuitry configured to divide the voxels of the 31) space into subsets of voxels including a first subset of voxels and a second subset of voxels. For voxels included in a first subset of voxels, the signal processing circuitry is configured to determine, for each voxel of the first subset of voxels, the predicted value of the voxel characteristic of other voxels within a specified distance thereof; adjust the voxel characteristic of individual voxels of the first subset of voxels using the predicted values of the voxel characteristic; and generate the indication of presence of the object in the voxels in the first subset of voxels using the adjusted voxel characteristics. For voxels included in the second subset of voxels, the signal processing circuitry is configured to compare the voxel characteristics to a threshold voxel characteristic value; and generate the indication of presence of the object in the voxels of the second subset of voxels using the comparisons to the threshold voxel characteristic value. In Aspect 10, the subject matter of one or any combination of Aspects 1-9 optionally includes a LIDAR sensor configured to obtain the LIDAR measurement data. The LIDAR sensor optionally includes a LIDAR signal transmit chain configured to transmit light pulses into the field of view; and a LIDAR signal receive chain including a photo-detector configured to detect light energy reflected by the object in the field of view in response to the transmit light pulses and determine the LIDAR measurement data using the detected light energy.

Aspect 11 includes subject matter (such as a LIDAR system) or can optionally be combined with one or any combination of Aspects 1-10 to include such subject matter, comprising a memory configured to store frames of LIDAR measurement data obtained by the LIDAR system, wherein a frame is representative of a sample of a three-dimensional (3D) space in a field of view of the LIDAR system and multiple frames represent multiple samples of the 31) space in time; and signal processing circuitry operatively coupled to the memory. The signal processing circuitry is configured to convert the LIDAR measurement data to a voxel characteristic for the voxels; identify voxels of the 3D space that are candidate voxels for being occupied by an object using the voxel characteristic; identify clusters of the candidate voxels as candidate clusters; and identify voxels corresponding to an object by applying one or more behavior constraints to the candidate clusters over multiple frames.

In Aspect 12, the subject matter of Aspect 11 optionally includes signal processing circuitry configured to identify a candidate cluster in a first frame corresponding to a first sample of the 3D space; identify the candidate cluster in a second frame corresponding to a second sample of the 3D space consecutive to the first sample; and apply a velocity constraint to the candidate cluster over the first and second frames to identify whether the voxels of the candidate cluster correspond to the object.

In Aspect 13, the subject matter of Aspect 12 optionally includes signal processing circuitry configured to identify the candidate cluster in a third frame corresponding to a third sample of the 3D space consecutive to the second sample; apply a first test of the velocity constraint to the candidate cluster over the first and second frames; apply a second test of the velocity constraint to the candidate cluster over the second and third frames; and identify that the voxels of the candidate cluster correspond to the object when the candidate cluster satisfies the first and second applied tests of the velocity constraint.

In Aspect 14, the subject matter of one or any combination of Aspects 11-13 optionally includes signal processing circuitry configured to identify a candidate cluster in a first frame corresponding to a first sample of the 31) space; identify the candidate cluster in a second frame corresponding to a second sample of the 3D space consecutive to the first sample; identify the candidate cluster in a third frame corresponding to a third sample of the 3D space consecutive to the second sample; and apply an acceleration constraint to the candidate cluster over the first, second, and third frames to identify whether the voxels of the candidate cluster correspond to the object.

In Aspect 15, the subject matter of Aspect 14 optionally includes signal processing circuit configured to identify the candidate cluster in a fourth frame corresponding to a fourth sample of the 3D space consecutive to the third sample; apply a first test of the acceleration constraint to the candidate cluster over the first, second, and third frames; apply a second test of the acceleration constraint to the candidate cluster over the second, third, and fourth frames; and identify that the voxels of the candidate cluster correspond to the object when the candidate cluster satisfies the first and second applied tests of the acceleration constraint.

In Aspect 16, the subject matter of one or any combination of Aspects 11-15 optionally includes signal processing circuitry configured to identify a candidate cluster in N frames, wherein N is an integer greater than or equal to two; and apply a least squares constraint to the candidate cluster over the N frames to identify whether the voxels of the cluster correspond to the object.

In Aspect 17, the subject matter of one or any combination of Aspects 11-16 optionally includes signal processing circuitry configured to convert the LIDAR measurement data to probability data as the voxel characteristic for the voxels, the probability data representing a probability that an object occupies the voxels; and identify voxels that satisfy a probability threshold as the candidate voxels.

In Aspect 18, the subject matter of one or any combination of Aspects 11-17 optionally includes signal processing circuitry configured to identify a cluster as a candidate cluster using one or more of a number of candidate voxels in the cluster and position of the cluster in the frame.

In Aspect 19, the subject matter of one or any combination of Aspects 11-18 optionally includes signal processing circuitry configured to identify a candidate cluster in a first frame corresponding to a first sample of the 3D space; identify the candidate cluster in a second frame corresponding to a second sample of the 3D space consecutive to the first sample; and apply a size constraint to the candidate cluster over the first and second frames to identify whether the voxels of the candidate cluster correspond to the object.

In Aspect 20, the subject matter of one or any combination of Aspects 11-19 optionally includes signal processing circuitry configured to identify a candidate cluster in a first frame corresponding to a first sample of the 3D space; identify the candidate cluster in a second frame corresponding to a second sample of the 3D space consecutive to the first sample; and apply a shape constraint to the candidate cluster over the first and second frames to identify whether the voxels of the candidate cluster correspond to the object.

In Aspect 21, can include subject matter (such as a LIDAR system) or can optionally be combined with one or any combination of Aspects 1-20 to includes such subject matter comprising a LIDAR signal transmit chain including a Laser diode and circuitry configured to drive the Laser diode to transmit a LIDAR pulse; a receive signal chain including a photo-detector configured to detect reflected LIDAR energy; a memory to store a time series of samples of the reflected LIDAR energy received at the receive signal chain; and an estimator circuit configured to estimate a distance of an object according to the time series of samples of LIDAR energy using a detection threshold, wherein the detection threshold varies with time over the time series of samples of LIDAR energy.

In Aspect 22, the subject matter of Aspect 21 optionally includes an estimator circuit configured to decrease the detection threshold with time over the time series of the samples of the LIDAR energy.

In Aspect 23, the subject matter of one or both of Aspects 21 and 22 optionally includes an estimator circuit configured to decrease the detection threshold according to a piece-wise constant function over the time series of samples of LIDAR energy.

These non-limiting Aspects can be combined in any permutation or combination. The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. Method examples described herein can be machine or computer-implemented at least in part.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim, Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A Laser Imaging Detection and Ranging (LIDAR) system, the system comprising:
a memory configured to store LIDAR measurement data obtained by the LIDAR system representative of a three-dimensional (3D) space in a field of view of the LIDAR system; and
signal processing circuitry operatively coupled to the memory and configured to:
convert the LIDAR measurement data to a voxel characteristic of voxels of the 3D space;
process and adjust a voxel characteristic of a first voxel of the 3D space using a voxel characteristic of other voxels within a specified distance of the first voxel in the 3D space;
continue to process and adjust the voxel characteristics of all voxels in the 3D space; and
generate an indication of presence of an object in the field of view according to the adjusted voxel characteristics.

2. The system of claim 1, wherein the signal processing circuitry is configured to:
convert the LIDAR measurement data to probability data as the voxel characteristic for the voxels, the probability data representing a probability that the object occupies the voxels;
adjust the probability data of the first voxel using probability data of the other voxels within the specified distance of the first voxel; and
generate the indication of presence of the object in the field of view according to the adjusted probability data of the voxels in the 3D space.

3. The system of claim 2, wherein the signal processing circuitry is configured to:
recalculate the probability data of the first voxel using the probability data of the other voxels multiple times;
compare the recalculated probability data of the first voxel and the other voxels to one or more specified probability thresholds; and
identify the voxels of the 3D space occupied by the object using results of the comparison of the recalculated probability data.

4. The system of claim 1, wherein the signal processing circuitry is configured to:
convert the LIDAR measurement data to a likelihood ratio as the voxel characteristic for the voxels, wherein the likelihood ratio is a ratio including a probability that a voxel is occupied by the object and a probability that the voxel is not occupied by the object;
adjust the likelihood ratio of the first voxel using the likelihood ratios of the other voxels within the specified distance of the first voxel;
continue to adjust the likelihood ratios of all voxels in the 3D space; and
generate the indication of presence of an object in the field of view according to the adjusted likelihood ratios.

5. The system of claim 4, wherein the signal processing circuitry is configured to:
compare the likelihood ratios of the first voxel and the other voxels to one or more threshold likelihood ratios; and
generate the indication of presence of an object in the field of view according to the comparisons of the likelihood ratios.

6. The system of claim 1, wherein the signal processing circuitry is configured to:
determine, for each voxel of the 3D space, a predicted value of the voxel characteristic of other voxels within a specified distance thereof;
adjust the voxel characteristic of individual voxels of the 3D space using predicted values of the voxel characteristic; and
generate the indication of presence of an object in the field of view according to the adjusted voxel characteristics.

7. The system of claim 6, wherein the signal processing circuitry is configured to repeat the determining of the predicted values of the voxel characteristic and the adjusting the voxel characteristic of individual voxels of the 3D space using the predicted values multiple times.

8. The system of claim 7, wherein the signal processing circuitry is configured to:
apply median filtering to the adjusted voxel characteristics of the voxels of the 3D space; and
generate the indication of presence of an object in the field of view according to the adjusted and filtered voxel characteristics.

9. The system of claim 6, wherein the signal processing circuitry is configured to:
divide the voxels of the 3D space into subsets of voxels including a first subset of voxels and a second subset of voxels;
for voxels included in a first subset of voxels:
determine, for each voxel of the first subset of voxels, the predicted value of the voxel characteristic of other voxels within a specified distance thereof;
adjust the voxel characteristic of individual voxels of the first subset of voxels using the predicted values of the voxel characteristic; and
generate the indication of presence of the object in the voxels in the first subset of voxels using the adjusted voxel characteristics; and
for voxels included in a second subset of voxels:
compare the voxel characteristics to a threshold voxel characteristic value; and
generate the indication of presence of the object in the voxels of the second subset of voxels using the comparisons to the threshold voxel characteristic value.

10. The system of claim 1, including a LIDAR sensor configured to obtain the LIDAR measurement data, the LIDAR sensor including:
a LIDAR signal transmit chain configured to transmit light pulses into the field of view; and
a LIDAR signal receive chain including a photo-detector configured to detect light energy reflected by the object in the field of view in response to the transmit light pulses and determine the LIDAR measurement data using the detected light energy.

11. A Laser Imaging Detection and Ranging (LIDAR) system, the system comprising:
a memory configured to store frames of LIDAR measurement data obtained by the LIDAR system, wherein a frame is representative of a sample of a three-dimensional (3D) space in a field of view of the LIDAR system and multiple frames represent multiple samples of the 3D space in time; and
signal processing circuitry operatively coupled to the memory and configured to:
convert the LIDAR measurement data to a voxel characteristic for the voxels;
identify voxels of the 3D space that are candidate voxels for being occupied by an object using the voxel characteristic;
identify clusters of the candidate voxels as candidate clusters; and
identify voxels corresponding to an object by applying one or more behavior constraints to the candidate clusters over multiple frames.

12. The LIDAR system of claim 11, wherein the signal processing circuitry is configured to:
identify a candidate cluster in a first frame corresponding to a first sample of the 3D space;
identify the candidate cluster in a second frame corresponding to a second sample of the 3D space consecutive to the first sample; and
apply a velocity constraint to the candidate cluster over the first and second frames to identify whether the voxels of the candidate cluster correspond to the object.

13. The LIDAR system of claim 12, wherein the signal processing circuitry is configured to:
identify the candidate cluster in a third frame corresponding to a third sample of the 3D space consecutive to the second sample;
apply a first test of the velocity constraint to the candidate cluster over the first and second frames;
apply a second test of the velocity constraint to the candidate cluster over the second and third frames; and
identify that the voxels of the candidate cluster correspond to the object when the candidate cluster satisfies the first and second applied tests of the velocity constraint.

14. The LIDAR system of claim 12, wherein the signal processing circuitry is configured to:
identify a candidate cluster in a first frame corresponding to a first sample of the 3D space;
identify the candidate cluster in a second frame corresponding to a second sample of the 3D space consecutive to the first sample;
identify the candidate cluster in a third frame corresponding to a third sample of the 3D space consecutive to the second sample; and
apply an acceleration constraint to the candidate cluster over the first, second, and third frames to identify whether the voxels of the candidate cluster correspond to the object.

15. The LIDAR system of claim 14, wherein the signal processing circuitry is configured to:
identify the candidate cluster in a fourth frame corresponding to a fourth sample of the 3D space consecutive to the third sample;
apply a first test of the acceleration constraint to the candidate cluster over the first, second, and third frames;
apply a second test of the acceleration constraint to the candidate cluster over the second, third, and fourth frames; and
identify that the voxels of the candidate cluster correspond to the object when the candidate cluster satisfies the first and second applied tests of the acceleration constraint.

16. The LIDAR system of claim 11, wherein the signal processing circuitry is configured to:
identify a candidate cluster in N frames, wherein N is an integer greater than or equal to two; and
apply a least squares constraint to the candidate cluster over the N frames to identify whether the voxels of the cluster correspond to the object.

17. The LIDAR system of claim 11, wherein the signal processing circuitry is configured to:
convert the LIDAR measurement data to probability data as the voxel characteristic for the voxels, the probability data representing a probability that an object occupies the voxels; and
identify voxels that satisfy a probability threshold as the candidate voxels.

18. The LIDAR system of claim 11, wherein the signal processing circuitry is configured to identify a cluster as a candidate cluster using one or more of a number of candidate voxels in the cluster and position of the cluster in the frame.

19. The LIDAR system of claim 11, wherein the signal processing circuitry is configured to:
identify a candidate cluster in a first frame corresponding to a first sample of the 3D space;
identify the candidate cluster in a second frame corresponding to a second sample of the 3D space consecutive to the first sample; and
apply a size constraint to the candidate cluster over the first and second frames to identify whether the voxels of the candidate cluster correspond to the object.

20. The LIDAR system of claim 11, wherein the signal processing circuitry is configured to:
identify a candidate cluster in a first frame corresponding to a first sample of the 3D space;
identify the candidate cluster in a second frame corresponding to a second sample of the 3D space consecutive to the first sample; and
apply a shape constraint to the candidate cluster over the first and second frames to identify whether the voxels of the candidate cluster correspond to the object.

21. A Laser Imaging Detection and Ranging (LIDAR) system comprising:
a LIDAR signal transmit chain including a Laser diode and circuitry configured to drive the Laser diode to transmit a LIDAR pulse;
a receive signal chain including a photo-detector configured to detect reflected LIDAR energy;
a memory to store a time series of samples of the reflected LIDAR energy received at the receive signal chain; and
an estimator circuit configured to estimate a distance of an object according to the time series of samples of LIDAR energy using a detection threshold, wherein the detection threshold varies with time over the time series of samples of the LIDAR energy.

22. The LIDAR system of claim 21, wherein the estimator circuit is configured to decrease the detection threshold with time over the time series of samples of the LIDAR energy.

23. The LIDAR system of claim 21, wherein the estimator circuit is configured to decrease the detection threshold according to a piece-wise constant function over the time series of samples of the LIDAR energy.
